(19) United States
(12) Patent Application Publication
(10) Pub. No.: US 2003/0153357 A1
(43) Pub. Date: Aug. 14, 2003

(54) Apparatus and method for determining an address in a telecommunication network

(76) Inventors: Anders Lundh, Durham, NC (US); Piroz Darai, Morrisville, NC (US); Vinh Luu, Morrisville, NC (US)

Correspondence Address: STEVEN B. PHILLIPS MOORE & VAN ALLEN, SUITE 800, 2200 WEST MAIN STREET, DURHAM, NC, 27705, US

(21) Appl. No.: 10/073,635

(22) Filed: Feb. 11, 2002

(51) Int. Cl. H04M 1/00

(52) U.S. Cl. 455/560; 455/463; 455/425; 455/561

(57) ABSTRACT

Apparatus and method for determining an address in a telecommunication network. A device includes a connection for a telecommunication network and a processing system which receives data through the connection and determines address information based on the occurrence of a flag in the data stream. A display on the device displays the address information, and possibly other information to a user. In one embodiment, the address information includes an origination point code and a destination point code in an SS7 network. The device can also optionally capture and display additional information. In one embodiment, micro code running on a DSP and EPROM controls the operation of the device and implements the method of the invention.

### BACKGROUND OF THE INVENTION

As the public switched telephone network (PSTN) has evolved, it has become necessary to significantly expand the signaling network, which transports information messages between switches and other devices within the network. This network, often called the advanced intelligent network (AIN), operates in parallel with the voice network in the circuit switched telephone system. The AIN uses a messaging protocol called signaling system 7 (SS7) to exchange call information between devices and nodes. The expansion of this network has resulted in numerous connections, also called links, between devices passing through various patch panels contained at switching points throughout the network. The interconnection of the PSTN with the public land mobile network (PLMN) has exacerbated the situation.

The situation described above creates difficulty during troubleshooting. Patch panels, which are used to make links between various nodes in the signaling network, have often become cluttered with unmarked connections. When it is necessary to determine which connection is for a specific node in the network, it is often also necessary to spend time tracing cable connections. FIG. 1 illustrates this situation. FIG. 1 illustrates two patch panels, 102 and 104. The patch panels interconnect remote base stations 106 and 108, as well as home location register 110, with a mobile switching center, 112. Because of the many crossovers and route changes encountered in the signal path between any two nodes, isolating a specific link can be difficult.

### BRIEF SUMMARY OF THE INVENTION

The present invention, in at least one embodiment, provides for a portable device which can be connected to a telecommunication network at a specific link, and quickly display address information for that link. In this way, the device allows for quick identification of a connection, which may be otherwise difficult to find, for example, at a patch panel. According to at least one embodiment of the invention, the device includes a connection for the telecommunication network, as well as a processing system that can receive a data stream through the connection and determine the address information contained in the data stream. In one embodiment, this determination is made based on the occurrence of a flag in a message signal unit (MSU). A display is operatively connected to the processing system for displaying the address information to a user. The device may be powered by a battery or similar self-contained power source disposed within the device via a suitable arrangement for suspending and connecting the power source.

In an SS7 network, the address information displayed typically consists of an origination point code (OPC) and a destination point code (DPC). In some embodiments the device can also isolate and determine an application part for an MSU. A device according to the invention in at least some embodiments operates by first receiving the data stream and detecting the occurrence of a flag within the data stream, which indicates the beginning of an MSU. Address bits are collected based on their positioning within the MSU relative to the flag. The address bits are parsed and the appropriate address information is displayed. If the device is enabled to determine and display an application part, bits from a specified field within the MSU are isolated and collected in order to determine and display the application part.

In some embodiments of the invention, the device operates through the use of computer program microcode disposed within an erasable, programmable, read-only memory (EPROM) within the device. A digital signal processor (DSP) is also present. These components and required supporting circuitry form the means to enable the device to operate as required.

### BRIEF DESCRIPTION OF THE DRAWINGS

FIG. 1 illustrates a potential operating environment of the invention, namely a network in which various nodes are interconnected through patch panels;

FIG. 2 is an external illustration of a device according to an embodiment of the present invention;

FIG. 3 is a functional block diagram of a device according to an embodiment of the present invention;

FIG. 4 illustrates one type of message signal unit (MSU) that the invention can detect in order to determine addressing and other information; and

FIG. 5 shows a flow chart, which illustrates the method of operation of the invention in at least one embodiment.

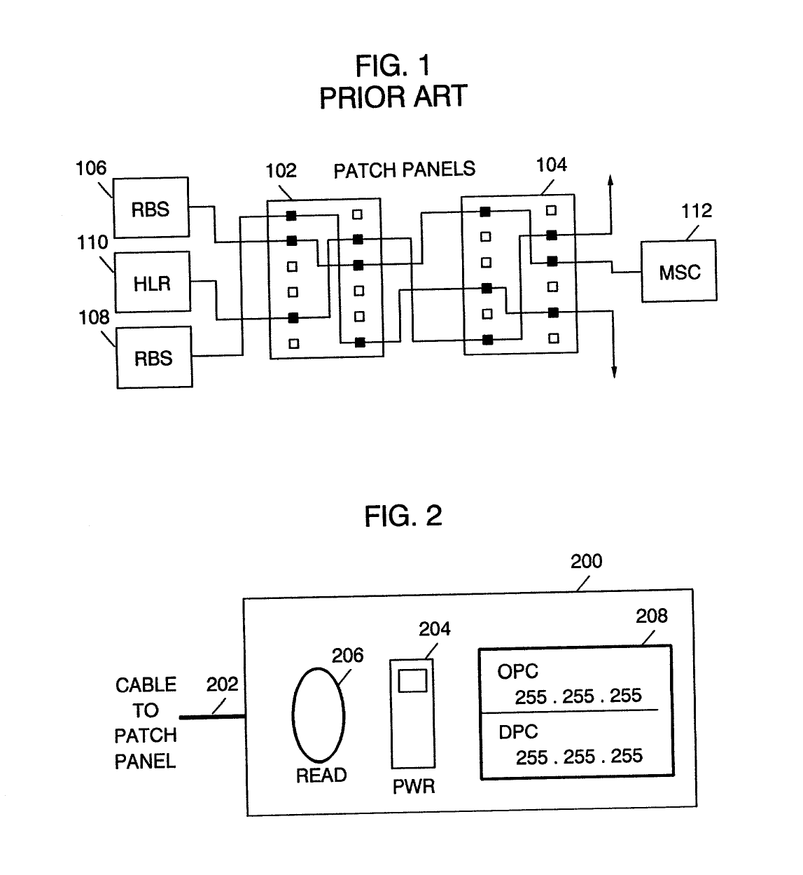

### DETAILED DESCRIPTION OF THE INVENTION

The present invention is disclosed in terms of one or more example embodiments described herein. In the example embodiments, a signaling network such as an SS7 network is illustrated as the operating environment for the invention. It should be understood that this operating environment is illustrated as an example only. The inventive concepts disclosed herein are equally applicable to other types of networks with other types of addressing schemes. The data streams described herein are illustrated in terms of a message signal unit (MSU), which is consistent with SS7 terminology. However, this term is not meant to be limiting. An MSU is simply a collection of bits in a particular format, which is used to carry information on the network. Generically, therefore, many types of networks include an (MSU) of some type.

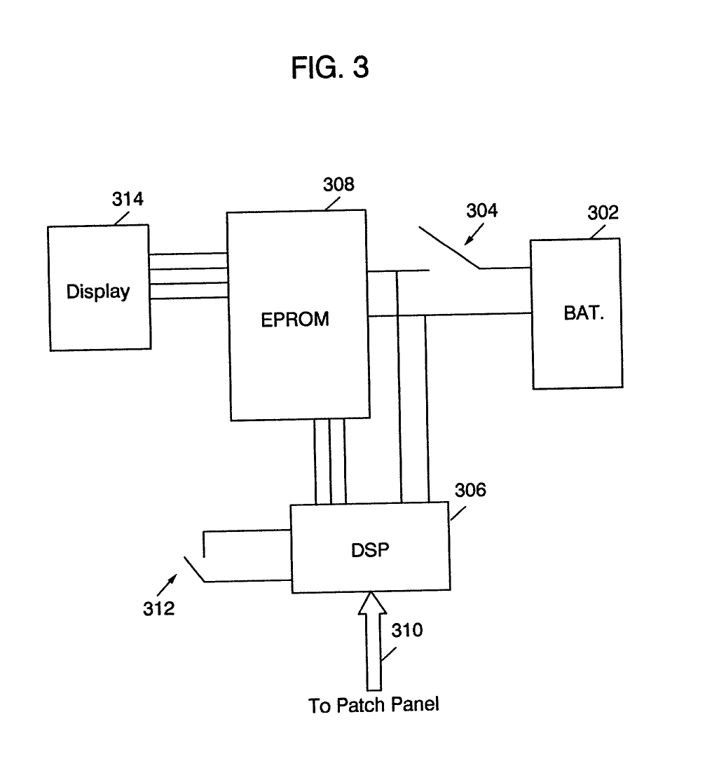

In the context of the above paragraph, FIG. 2 illustrates how a device which implements the invention would appear to and be used by a user in at least one embodiment of the invention. In FIG. 2, a portable device, 200, includes a cable 202, which serves as a connection to a link in a telecommunication network. This cable is terminated in a suitable connector allowing it to be connected to a patch panel as appropriate. Switch 204 applies power to the unit when desired. In the illustration of FIG. 2, switch 204 is illustrated as a sliding type power switch. Other types of switches could be used, and in fact, this switch may serve multiple functions. For example, the switch may be a multi-position switch that not only applies power, but also puts the device into different modes of operation. Examples might include modes directed at operating with different types of networks, and possibly a diagnostic mode vs. a normal operation mode. Read button 206 directs a digital signal processor (DSP) contained in the device to begin to analyze a data stream. The DSP is discussed in further detail with respect to FIG. 3. Finally, display 208 displays the appropriate address information. In the example of FIG. 2, display 208 displays an origination point code (OPC) and a destination point code (DPC). The display can also display other information such as an application part name in the case of an SS7 network. In this particular embodiment, if the device is unable to collect the appropriate bits in order to be able to display an address, the display will flash the message “No Data” after a suitable period of time.

FIG. 3 is a functional block diagram illustrating the major components within a device according to an embodiment of the invention. The device of FIG. 3 is powered by a battery, 302. Power switch 304 applies power to the unit. It should be noted that additional power connections to the display and possibly other components may be present, but are omitted for clarity. In operation, the battery is contained in the device within a suitable arrangement, for example, a clip-style battery holder with appropriate electrical terminals to interface the battery to the various components of the device. DSP 306 and EPROM 308 form a miniature, processing system that is operable to receive the data stream through a connection 310. In practical application, this connection is implemented by a cable as shown at 202 of FIG. 2. Switch 312 is the read switch that causes the device to begin gathering data.

The DSP of FIG. 3 isolates groups of bits and sends the groups to the EPROM, 308, where computer program code in the form of microcode collects, parses, and analyzes the bits to determine the desired address information. Code within the EPROM can also extract other information from an MSU. For example, as will be discussed in further detail below, an application part designation can be extracted. When the appropriate address information has been determined, it is displayed on display 314. Display 314 may be a liquid crystal display (LCD), a light emitting diode (LED) display, a fluorescent tube display, or any other suitable display device. A useful device can be implemented with a display that is capable of displaying only numerical data. However, there are advantages to having a display that can also display alphabetical data. Such as display could be used to display error messages in natural language (such as “No Data”), and to display a translation of bit information such as an application part into normal language text.

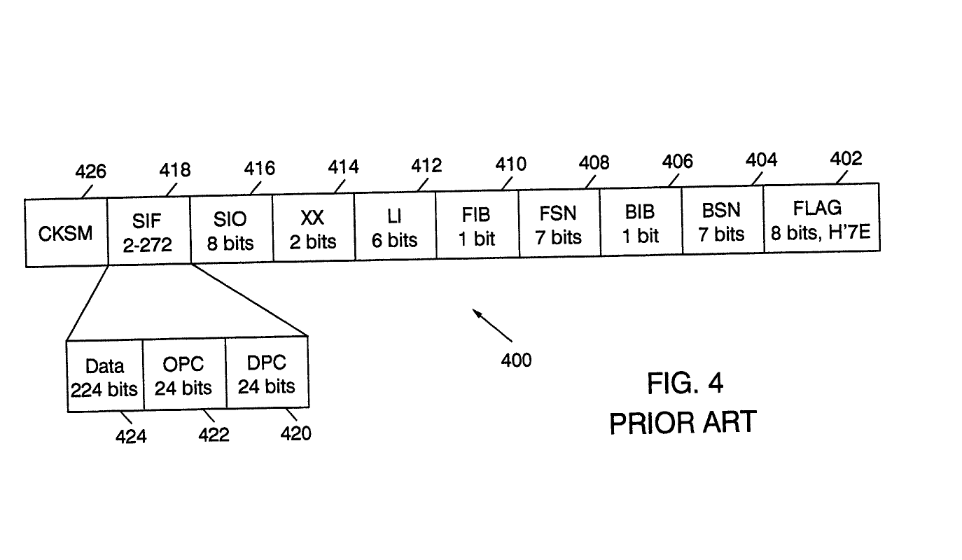

A detailed discussion is now provided as to the mechanism by which the device isolates address information such as origination and destination codes. To aid in understanding this detailed discussion, an SS7 MSU is diagrammed in FIG. 4. The signaling source at a patch panel in this embodiment provides digital bits sent in five (5) volt and zero (0) volt pulses. Each 5-volt pulse is considered to be a bit value of one (1). Each 0-volt pulse is considered to be a bit value of zero (0). Messages of this type are measured in octets where one octet is eight bits. The message unit 400 of FIG. 4 can be conceptualized as traveling over the network from left to right, therefore, it would be read from right to left. Thus, flag 402 would be encountered first by the device.

There are three basic message formats used within the SS7 protocol. They are the fill-in signal unit (FISU), the link status signal unit (LSSU), and the message signal unit (MSU). The MSU, which has been previously discussed, is the type of message that contains the desired address information. An FISU is used for synchronization and an LSSU is sent to describe events that effect the link's ability to carry traffic. The FISU and LSSU do not have the appropriate flag in the first octet, and therefore, are ignored by the device of the invention. Flag 402 is eight bits long. This flag, which indicates the beginning of an MSU, carries the hex value H7E, which is 011111110 in binary. The next seven bits of the MSU, 404, form a backwards sequence number (BSN) which is used for message verification. The next bit, 406, is a backward indicator bit (BIB). Forward sequence number (FSN) 408 is seven bits long The forward indicator bit (FIB), 410, is a single bit. The length indicator (LI), 412, is six bits long. Two unused bits, 414, follow and are indicated with an “XX” in FIG. 4. All of the fields discussed thus far, except the flag, are standard, known fields, which are unimportant to the operation of the invention and will not be discussed further.

The service information octet (SIO), 416, is eight bits long. This octet identifies different message priorities, network types, and application parts. The message priorities and network types are not important in the context of the invention, however, it can be useful for a trouble shooter to know what application part is being used at a particular link. This will be discussed later.

The service information field (SIF), 418, is present in all types of SS7 message formats. It varies in length from 2 to 272 bits, depending on its contents. However, in the case of an MSU, it always contains a 24 bit DPC, 420, a 24 bit OPC, 422, and data, 424, which can be up to 224 bits long. An MSU such as that illustrated in FIG. 4 also contains a check sum, 426.

Upon observing the MSU of FIG. 4, and counting the appropriate bits, it can be seen that the DPC begins after exactly 32 bits have passed since the end of the flag. The DPC has 24 bits and will be displayed by the software of the device as a decimal format address with three fields. Likewise, the OPC is the next 24 bits and will be similarly displayed. Examples of addresses in these formats are shown being displayed in FIG. 3.

As previously mentioned, the SIO, 416, includes the application part of the message. This information is encoded in the first four bits of this octet. A breakdown of the meaning of various combinations of these bits is illustrated below:

0000=Signaling Network management Messages

0001=Signaling Network testing and Maintenance Regular Message

0010=Signaling network Testing and maintenance Special Messages

0011=SCCP

0100=Telephone User Part

0101=ISDN User Part

0110=Data User Part

0111=Data User part

1000=MTP Testing User Part

1001=Broadband ISDN User Part

1010=Satellite ISDN User Part

1011=Spare

1100=Spare

1101=Spare

1110=Reserved for Individual network use

1111=Spare

Two entries in the list above bear particular mention. A “0100” in the first four bits of the SIO defines the telephone user part (TUP) as the application part. TUP is considered the most standard, generic form of SS7 signaling, and is often referred to simply as SS7 signaling. A “1011” or any of the other spare entries in the list above can be used to indicate a standard such as American National Standards Institute (ANSI) standard ANSI-41, also called International Standard (IS) IS-41. IS-41 is a modified application part that performs signaling between the PSTN and various nodes that connect the PSTN to the PLMN. IS-41 is important since this is the type of signaling often encountered in some of the most cluttered patch panels, where connections are made to and from both the PSTN and the PLMN. The other entries in the table above represent well-known, standard application parts.

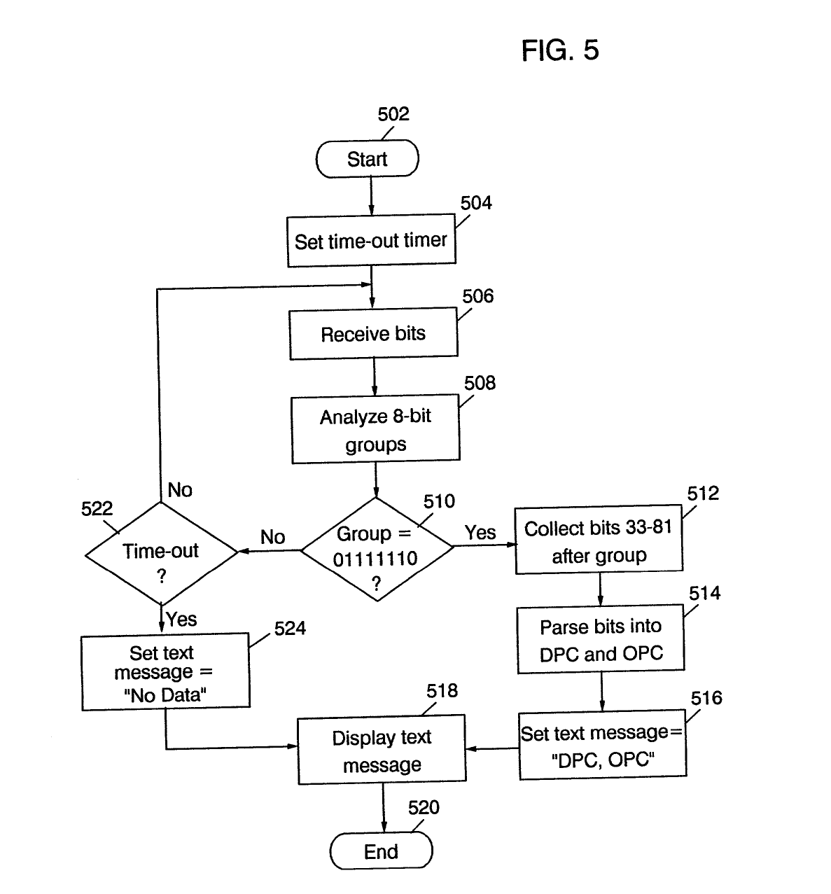

FIG. 5 is a flow chart illustrating the method of operation of the present invention. The start button is pressed at step 502 initiating data collection. The code within the device sets out a time-out timer at step 504 and the DSP receives bits at step 506. At this time, the DSP also parses the data stream, in a rolling fashion, into eight bit groups, which are stored and then analyzed at step 508. If a group having the flag value is detected at step 510, bits numbered 33 through 81 are then collected at step 512. These bits are parsed into the DPC and OPC at step 514. A text message to be displayed is set at step 516 to be equal to the DPC and OPC. The message is displayed on the display at step 518. The process ends at step 520 until the next time the start button is pressed.

Error handling is provided as shown in FIG. 5 for the case where the flag is never detected. As long as the flag is not detected at step 510, the timer is checked at step 522. If the timer has not timed out, the process continues with bits being received as shown. However, if the timer has timed out, the text message to be displayed is set to “No Data” as shown in step 524. When the message is displayed at step 518, the user can see that there has been some problem in gathering the address information required.

Specific embodiments of an invention are described herein. One of ordinary skill in the circuit and networking arts will quickly recognize that the invention has other applications in other environments. In fact, many embodiments and implementations are possible. The following claims are in no way intended to limit the scope of the invention to the specific embodiments described above. In addition, the recitation “means for” is intended to evoke a means-plus-function reading of an element and a claim, whereas, any elements that do not specifically use the recitation “means for”, are not intended to be read as means plus function elements, even if they otherwise include the word “means”.

What is claimed is:

1. A device for use in acquiring address information at a link in a telecommunication network, the device comprising:
a connection for the telecommunication network;
a processing system operable to receive a data stream through the connection and determine the address information contained in the data stream based on the occurrence of a flag in a message signal unit (MSU) contained in the data stream;
a display operatively connected to the processing system, the display operable to display the address information; and
an arrangement for supplying power to the display and the processing system from a self-contained power source.

2. The device of claim 1 wherein the address information comprises:
an origination point code; and
a destination point code.

3. The device of claim 2 wherein the processing system is further operable to determine an application part based on a specified field within the MSU, and wherein the display is further operable to display the application part.

4. The device of claim 2 wherein the MSU is a signaling system seven (SS7) MSU.

5. Apparatus for use in acquiring address information at a link in a telecommunication network, the apparatus comprising:
means for connection for the telecommunication network;
means for receiving a data stream through the means for connection;
means for determining the address information contained in the data stream based on the occurrence of a flag in a message signal unit (MSU) contained in the data stream; and
means for displaying the address information, the means for displaying operatively connected to the means for determining.

6. The apparatus of claim 5 further comprising means to determine and display an application part.

7. A method of presenting address information at a link in a telecommunication network, the method comprising:
receiving a data stream;
detecting the occurrence of a flag in the data stream, the flag indicating a beginning of a message signal unit (MSU) contained within the data stream;
collecting address bits based on a positioning of the address bits within the MSU relative to the flag;
parsing the address bits to determine the address information; and
displaying the address information.

8. The method of claim 7 wherein the parsing of the address bits is accomplished at least in part by determining an origination point code and a destination point code contained within the address information.

9. The method of claim 8 further comprising:
collecting application part bits from a specified field within the MSU;
determining an application part based on the application part bits; and
displaying the application part.

10. The method of claim 8 wherein the MSU is a signaling system seven (SS7) MSU.

11. Apparatus for presenting address information at a link in a telecommunication network, the apparatus comprising:
means for receiving a data stream;
means for detecting the occurrence of a flag in the data stream, the flag indicating a beginning of a message signal unit (MSU) contained within the data stream;
means for collecting address bits based on a positioning of the address bits within the MSU relative to the flag;
means for parsing the address bits to determine the address information; and
means for displaying the address information.

12. The apparatus of claim 11 further comprising:
means for collecting application part bits from a specified field within the MSU;
means for determining an application part based on the application part bits; and
means for displaying the application part.
